(19) United States
(12) Patent Application Publication
(10) Pub. No.: US 2008/0000581 A1
(43) Pub. Date: Jan. 3, 2008

(54) Preparation of laminated composite substrates using coated oriented polymeric film

(76) Inventors: Gilles Leon Nison, Lexy (FR); Tarquin L. Crouch, Southborough (GB)

Correspondence Address: ExxonMobil Chemical Company;Law Technology, P.O. Box 2149, Baytown, TX, 77522-2149, US

(21) Appl. No.: 11/477,054

(22) Filed: Jun. 28, 2006

(51) Int. Cl. B32B 27/38; B32B 15/04; B32B 27/30; B32B 27/32; B32B 27/42; B32B 3/26; B32B 37/00

(52) U.S. Cl. 156/272.2; 428/522; 428/304.4; 428/537.1; 428/523; 428/323; 428/910; 428/336; 428/414; 428/524; 428/457; 156/272.6

(57) ABSTRACT

Disclosed is the preparation of a laminated composite structure. Such laminate composites comprise a base layer comprising a base substrate; at least one polymeric layer laminated onto a surface of the base substrate. The polymeric layer is preferably decorative on an exterior surface and is preferably bonded to the base substrate using a thermosetting adhesive interposed between the substrate surface and the polymeric layer. The polymeric layer comprises an opaque, polymeric, e.g., polypropylene-based, film which has a cavitated core and a coating thereon, which is preferably an acrylic-based coating applied to both sides of the film. Such laminated structures can be produced by passing the requisite base layer, polymeric layer film and adhesive through sets of rollers or drums which supply the heat and/or pressure needed to adhesively bond the layers together.

### FIELD OF THE INVENTION

The present invention relates to the lamination of polymeric films onto base substrates, the laminated composite structures created thereby, and methods for producing such structures. The laminated composite substrates according to this invention may be useful as decorated, functional, and/or structural components.

### BACKGROUND OF THE INVENTION

Industries utilizing rigid substrate components or materials, such as the construction and furniture manufacturing industries, are known to use various types of laminated products for structural components of walls, flooring, cabinetry, furniture, trim material, and other structural members. The base substrates for such materials commonly comprise wood-based products, such as those made from lumber-based materials. Other base substrates include polymer-base materials which may be coextruded, pressed, or molded into a particular shape product. Due to variations in materials, environmental exposures, and desired performance conditions, base substrate selection and desirability for particular applications may vary. To improve functionality and/or appearance, a substrate may be laminated or bonded to another substrate to combine the attributes of each material into a composite material.

For example, some relatively inexpensive base materials may be combined with a relatively more expensive but more attractive thin wood veneer to give the appearance of an expensive piece of wood, while conserving cost and providing desired structural performance. However, as trees of the required type, size, and quality that provide a source for such wood veneers become scarce, the manufacture of wood veneers may also become more expensive.

To maintain costs of construction as reasonable and practical, while still producing houses and furniture of acceptable quality and performance, some alternative, wood-based products have been developed. For example, particleboard, fiberboard, orientated strandboard, hardboard, chipboard, plywood, and other manufactured boards have been formed from relatively low-grade wood or plant-based fibers that may not otherwise be usable in the construction industry. Also, boards or substrates formed from wood particles, such as wood chips, sawdust, wood flakes, or other wood fragments are also being used more and more frequently in the construction industry, particularly for hidden, subsurface substrates, where such materials may provide the required structural integrity properties without the need for aesthetic appeal.

However, such alternative wood products may be characterized by uneven, rough, and unattractive surfaces that may not provide a “finished” look. To facilitate use of such alternative wood products in applications where appearance properties are valued, the substrate or base formed from low-grade wood or wood products may include a finished or decorative top layer adhered to the substrate to provide the desired attractive and/or protective finish. In some embodiments, a layer of aesthetically appealing veneer of real wood may be laminated to a substrate or a veneer of another material, such as vinyl products. In some cost-sensitive applications, the top layer may be resin-impregnated paper (e.g., 45 to 90 grams per square meter) which may be printed with inks to yield a desired color or pattern (such as a wood-grain pattern) and provided with a scratch resistant overlacquer. The outer layer of decorative paper may be laminated to a wood-based substrate using relatively inexpensive, thermally-cured, two-component adhesives, such as urea formaldehyde. Some paper-based alternative wood products can be manufactured at a lower cost than corresponding vinyl covered or wood veneer covered laminates and in many instances may also provide superior aesthetics and performance.

Nevertheless, despite their lower cost and desirable aesthetic properties, decorative paper-laminated substrates can be too fragile or lack the desired durability for many applications for wood-based laminate products. In particular, the decorative paper may easily become damaged during normal use, due to the relatively delicate nature of paper, which may thereby mitigate any aesthetic advantages.

As a substitute for paper decorative layers, it is also known to utilize certain polymer-based substrates, such as polyvinyl chloride (PVC) or other vinyl-based materials. Such polymer coated substrates may offer several known advantages over paper-based materials, particularly with respect to durability, barrier, and structural properties. One significant disadvantage of such polymer covered substrates is that many tend to have relatively low surface energy, thereby lacking water-wetting capability, rendering such materials difficult to coat, print or decorate.

Other polymer films have known disadvantages and are not used for lamination to base substrates. For example, oriented polypropylene film is known to be difficult to print or coat with water-based inks and lacquers and may be resistant to bonding with water-based adhesives. These limitations may be overcome in some applications by treating the surface of the polymer film to increase the surface energy thereof. In applications, the film may require treating on both surfaces, such as for bonding to printing inks on one surface and bonding with an adhesive on the second surface. Use of polymer materials as a laminating material may also typically require the use of more expensive hot melt adhesives for the preparation of the laminated substrate products, as compared to glues. Another disadvantage of known polymer-coated, wood-based substrates is that the wood-substrate must be finished to a relatively smooth finish before bonding with the polymer layer because the polymer layers can transfer the appearance of irregularities from the surface of the wood substrate to the outer surface of the polymer layer. A significant disadvantage of using polymer films as the polymer substrates in the laminations has been their inability to mask surface defects, irregularities, or other substrate imperfections. Without good preparation of the wood surface, the wood or substrate grain or surface pattern can be observed in the polymer skin layer. Another disadvantage of known polymer laminated substrates is that to get a desired color often requires use of substantial quantities of pigments, dyes, coloring agents, and/or film thickness to masque the underlying wood grain or substrate color such that the finished product has a uniform color or appearance, and of sufficient tint and intensity. Another significant disadvantage of using polymer laminates on wood-based substrates is that they typically require use of relatively expensive and manufacturing-time-consuming hot-melt adhesives.

Attempts have been made to prepare a composite structure that includes a polymeric layer laminated to a wood-based substrate. However these systems and products have either been unsuccessful or have severe disadvantages, failing to produce the desired product. For example, attempts have been made to laminate a cast polypropylene film to a wood-based substrate. The final products failed to adequately masque surface features of the wood-based substrate, did not print well, did not bond well to the adhesives, and required hot-melt adhesives to adhere. Some embodiments also exhibited some wrinkling and lay-flat problems with the polymeric layer when preparing larger sized samples. The initial samples were relatively thick, having a thickness of about 120 microns (about 5 mils). Layer thicknesses were increased in latter attempts to correct some of these deficiencies. While this served to mitigate some of the masking problems, it added other problems such as haze and clarity issues, while failing to address all of the other fitness-for-use issues and was considered unsuccessful.

Accordingly, it is desirable to provide an outer layer polymeric material for lamination with substrates and more desirably with wood-based substrates that provide many of the performance advantages of polymer materials as well as many of the cost advantages of paper-based outer layer substrates. It is also desirable to have a product that overcomes the limitations or disadvantages discussed above and that are otherwise known to exist within the art.

### SUMMARY OF THE INVENTION

In one aspect, the present invention is directed to laminated composite structures comprising; A) at least one base layer comprising a base substrate; B) at least one polymeric layer including a cavitated, oriented polymeric film that is coated on at least one surface of the polymeric layer; and C) an adhesive interposed between both the base substrate and the at least one polymeric layer to bond the polymeric layer to the base layer. In many embodiments, the base layers preferably include wood-based substrates, the polymeric layer(s) are preferably decorative and opaque oriented polymeric film, such as an oriented polypropylene (OPP) film. The adhesive used to bond the wood-based substrate and the coated film-containing polymeric layer(s) together preferably comprises a thermosetting adhesive composition. The polymeric layer is preferably coated with an acrylic-based coating composition.

In another aspect, the present invention is directed to a process for preparing the laminated composite structures described herein. In a first step, a lamination zone is provided that includes one or more of a heating component, a radiating component, a pressurizing component, and/or an adhesive-applying component. In another step, a base layer comprising at least a base substrate is conveyed to the lamination zone. At least one polymeric layer comprising a coated, cavitated, oriented, polymeric film is also conveyed to the lamination zone where the polymeric layer is brought into contact with at least one surface of the base substrate. Prior to bringing the polymeric layer into contact with the base substrate within the lamination zone, an adhesive, preferably a thermosetting adhesive is applied to at least one of the base substrate-contacting side of the polymeric layer and/or to the polymeric layer-contacting surface of the base substrate. (The adhesive may be applied within or outside or the lamination zone.) After bringing the substrate, the adhesive, and the polymeric layer into contact, at least one of heat, radiation, and/or pressure are applied, as appropriate, to activate or set the adhesive, and/or to ensure smooth, even bonding, to fixedly bond the three components together and form a laminated composite substrate. When such steps are appropriate, sufficient heat and/or pressure may be supplied via the heat, radiation, and pressure-providing components to at least partially cure and preferably to fully cure the thermosetting adhesive and thereby form the desired laminated composite structures.

Surprisingly, the cavitated polymeric film within the polymeric layer provides a smooth, aesthetically appealing exterior surface on the composite structure while masking the surface irregularities or wood grain of the base substrate. Additionally, the coating on the polymeric substrates may facilitate a strong bond between the polymeric substrate and the adhesive, and provide for a decorative or printable exterior surface on the composite structure.

### BRIEF DESCRIPTION OF THE DRAWING

FIG. 1 illustrates an example of an apparatus arrangement that may be useful for carrying out a process for preparing the laminated composite structure of the present invention.

### DETAILED DESCRIPTION OF THE INVENTION

In some preferred embodiments, the present invention relates to a laminated composite structure comprising a base layer laminated to an oriented, coated, cavitated, polymer film, using an adhesive to bond the two layers together. This laminated composite structure may be printed or embossed, and/or further coated or laminated, to provide a decorative or otherwise desirable exterior appearance and surface properties that do not manifest the irregularities or roughness of the surface of the base layer on the exterior surface of the composite structure. The laminated composite structure may be a generally rigid member and often a generally planar member, such as a board or panel that may be further suitable for use in the fabrication or construction of articles or structures. The laminated composite structure may be used, for example, in the fabrication or construction industries such as for walls, flooring, cabinetry, furniture, countertops, and other surfaces that may benefit from the combined properties provided by a polymer surface plus a rigid member component.

In one preferred embodiment, the laminated composite structure may be substantially planar and resemble a sheet of plywood or wallboard that includes a polymer substrate bonded to one surface thereof. In another embodiment, the laminated structure may comprise non-planar aspects, such as curved and/or angular conformities, such as on trim molding or edging. In still other embodiments, the non-planar conformities may be used in combination with planar surfaces or components.

Preferred embodiments of the laminated composite structures may be essentially complete following lamination of the polymeric layer to the base layer or may be further processed following lamination to provide the desired decorative appearance on the outer surface of the polymeric layer(s). For purposes of the present invention, the laminated composite structure may be considered “decorative” if the structure itself, or polymeric layer thereof, has a different appearance from the surface of the base substrate element of the structure. Decorative structures or layers may be applied such as by printing and/or embossing, and may include, for example words, letters, colors, shading, and/or special designs, such as a tile pattern or wood grain, which imparts to the structure an appearance that denotes a finished product.

In addition to providing aesthetic benefits, the laminated composite structures according to this invention may also provide other improved properties, such as thermal insulating properties. In some embodiments, the cavitated layer may provide some aspect of thermal insulation, which may provide a more appealing sense of touch or feel to an end-user, due to less-noticeable temperature differences, as compared to the non-cavitated films. Exemplary embodiments and components of the laminated composite structure according to this invention are discussed herein.

### Base Layer

In many preferred embodiments, the base layer comprises a base substrate that is substantially rigid or relatively stiff, as compared to the flexible properties of a polymer film or paper-substrate. Though in many preferred embodiments the base layer will comprise primarily only a base substrate, in some alternative embodiments the base layer may also comprise other components, such as other base substrates, polymer components, foils, other adhesive layers, coatings, or other materials necessary to suit the application of interest.

In many embodiments, the base layer is a relatively flat, substantially planar, integral sheet or board, but may be in any three-dimensional shape or configuration. The actual product form of the base substrate, although typically in a structurally integral sheet or board form, may vary widely. The base layer must have a surface to which a polymeric layer of film can be adhered, such as by lamination. However, that surface may be planar, curved, concave, convex, angular, etc. The shape of the base layer surface may also be in any configuration such as square, rectangular, circular, triangular, acicular, elongate, elliptical, trapezoidal, etc. The surface of the base substrate, in fact, can be any plane or curved locus of points which defines the boundary of the three-dimensional substrate structure. The thickness of the base layer is not critical and will vary according to the intended application and may be limited by the limits of the manufacturing equipment. However, in some preferred embodiments, the base may typically have a thickness of from about 1 mil to about 2000 mil, with a more typical range of from about 10 mil to about 750 mil.

In many preferred aspects, the base layer or the base substrate may at least partially comprise and often may fully comprise a wood-based substrate or product. The wood based substrate may be defined broadly to include substantially any product that is derived from trees, such as chips, flakes, sawdust, veneers, solid lumber, paper, or fragments, as well as from agricultural or other plant products such as straw or other fibrous material. Such non-tree materials may also include rye straw, wheat straw, hemp stalks, sugar cane, and the like. Thus, for purposes of this invention, a substrate is “base” if it comprises any of the above-described lignin-containing materials, in addition to those materials derived from trees. Exemplary suitable base-substrates may include but are not limited to particleboard, fiberboard, orientated strandboard, hardboard, waferboard, plywood, chipboard, strawboard, melamine board, Masonite, homasote, wood veneer, MDF board, an extruded polymer-based member, solid lumber, and the like. Plywood, waferboard, and particle board, typically from ⅛th inch to ¾ inches thick are common exemplary base substrates. Such materials are generally rigid or stiffer than typical paper or polymer film substrates, and may be suitable for further machining, gluing, cutting, milling, routing, drilling, nailing, screwing, and/or joining with other structural members. As can be seen, substrates derived from wood or lignin-containing materials other than those coming from trees can also be used in the invention.

Techniques for manufacturing some preferred, wood-based, base substrates are well known in the art. For example, such substrates may be manufactured by compressing and/or heating (typically at temperatures of up to about 190° C.) the wood particles to form structurally rigid, integral sheets. A bonding agent is normally applied to the surface of the wood particles prior to pressing, and examples of such bonding agents are urea/formaldehyde resin, phenol/formaldehyde resin, melamine/formaldehyde resin, polymeric isocyanate resin and the like. The bonding agent may be in either powder or liquid form and is preferably a phenol/formaldehyde resin which is typically applied in amounts in the range of 1.8 to 2.3% by weight to the wood particles. In addition, a wax such as a petroleum-based wax, may also be applied to the wood particles, typically in amounts in the range of 1%-2% by weight of the wood particles to improve water resistant properties. In addition, preservatives and other additives may also be applied to the wood particles as is conventional.

One or both surfaces of the base layer may be finished or sanded as appropriate for the intended application, though the exterior surfaces of such substrates may not require as smooth of a finish as prior art base substrates that may have been laminated with a non-cavitated film. One or both surfaces of the base layer may also be coated, primed, stamped, or otherwise prepared as desired. The base layer may also be combined with other base layers or base substrates to prepare a multilayer base substrate or a multilayer base layer. In addition to supporting the polymeric layer and the aesthetic attributes thereof, another primary function of the base layer is to provide a substantial portion of the structural or mechanical integrity of the final laminated composite structure. The base layer may also perform other functions, such as environmental resistance, opacity, density, and insulation.

The base substrate supports a polymeric layer comprising a polymeric film layered to at least one of the base layer's outer surfaces. The polymeric layer may provide a decorative outer layer on the base layer, thereby providing the desired “finished” look to the resulting laminated composite structure. A polymeric layer also may be applied to more than one surface of the base substrate. Thus, the composite structure may include a polymeric layer laminated onto both sides of the composite structure. The two polymeric layers may be the same of different polymeric layers and further, one or both of the polymeric layers may be according to this invention. For example, one polymeric layer may be a cavitated, coated polymer film according to this invention, while the other side may be a non-cavitated film. A polymeric layer may also be applied to the sides or edges of the laminated composite structures (profiles) to provide a “finished” edge trim.

### Polymeric Layer

Laminated composite structures according to this invention comprise at least one polymeric layer that includes a cavitated, oriented, polymeric film, and wherein the polymeric layer includes a coating on at least one outer surface of the polymeric layer. The at least one polymeric layer preferably includes a polymeric film having a cavitated layer therein, and preferably a multilayer polymeric film having at least a cavitated core layer that is coated on either side or both sides of the core layer. Other layers may also be present, such as a skin layer(s) and a tie layer(s). Suitable polymeric films may include generally any thermoplastic film that exhibits thermoplastic properties and can be cavitated and coated. Exemplary polymer films include, but are not limited to, olefinic-polymer films, such as those homo- and co-polymers comprising one, two, three, or more monomers and/or comonomers, and blends thereof. For example, homo- or copolymers (including ter-polymers and higher numbers of comonomers) of ethylene, propylene and/or butylene. Some particularly preferred embodiments may include polymers comprising polypropylene. The polymeric layer is also oriented to, among other benefits of orientation, cavitate one or more layers of the polymeric film that comprises the polymeric layer. The laminated composite structure may comprise more than one polymer layer and each polymeric layer may comprise one or more polymeric films. The polymeric layer may comprise a monolayer polymer film, a multilayer polymer film, or a mono- or multilayered polymer film plus another component such as a foil layer, paper, or another thermoplastic substrate.

Preferred thermoplastic polymers for use in the core of the polymeric films comprise the polyolefins and especially such materials as syndiotactic or isotactic polypropylene. For example, one preferred material for the core of the films used herein comprises isotactic polypropylene homopolymer that includes about 93% to about 99% isotactic index, a crystallinity of about 70% to about 80%, and a melting point of from about 145° C. to about 167° C.

Orientation facilitates cavitating the film to render the film opaque and to provide loft to the film, as compared to an oriented, non-cavitated film. Lofting refers to an observed increase in overall film thickness due to the filling of the voids or cavities (that are induced during cavitation of the film) with air or gas. This may occur naturally as a product of cavitation that occurs during orientation. Thereby, a lofted film will have an increased optical gauge thickness as compared to a comparable film that is not cavitated. The film may be mono-axially oriented or biaxially oriented, sequentially or simultaneously. To impart opacity and loft to the film used in the polymeric layer(s), the core of the film is cavitated. Cavitation can occur, for example, by conventional particulate cavitation and/or by beta nucleation, (converting the alpha form polypropylene to the beta-form polypropylene), which may be facilitated either with or without a nucleating agent. If the orienting and extruding conditions require a nucleating agent, a beta-nucleating agent may be added to a polypropylene extrusion-melt. This causes the beta-crystalline form of polypropylene to be produced in films prepared from the melt. (See U.S. Patent Publication No. 2006/0024520, incorporated herein by reference.)

More commonly, film cavitation may be created by including in the core, prior to orientation, one or more cavitating agents. The cavitating agents are incompatible or immiscible with the polymeric matrix material and form a dispersed phase within the polymeric core matrix material before extrusion and orientation of the film. When such a polymer substrate is subjected to uniaxial or biaxial stretching, a void or cavity forms around the distributed, dispersed-phase moieties, providing a film having a matrix filled with numerous cavities that provide an opaque appearance due to the scattering of light within the matrix and cavities.

Cavitating agents can comprise inorganic or organic particulate material that is incompatible with the matrix polymer. Organic cavitating agents have a melting point that is higher than the melting point of the polymeric matrix material. Use of cavitating agents are described in U.S. Pat. No. 4,377,616, the entire disclosure of which is incorporated herein by reference. For example, organic cavitating agents may be selected from polymeric materials, such as, for example, polyesters like polybutylene terephthalate (PBT) or nylon (e.g., nylon-6); polycarbonate; acrylic resins; ethylene norborene copolymers, and the like. Exemplary inorganic cavitating agents may include glass, calcium carbonate, metal, or ceramic, or mixtures thereof, may also be used.

The cavitating agent may commonly be in particulate form. The particle size of cavitating agents in the dispersed phase is such that at least a majority by weight of the particles comprise an overall mean particle diameter, for example, of from about 0.1 micron to about 5 microns, more preferably from about 0.2 micron to about 2 microns. (The term “overall” refers to size in three dimensions; the term “mean” is the average.) The incompatible cavitating agent may be present in the core layer in an amount of from about 2 wt % to about 40 wt %, based upon the total weight of the cavitated core layer, or more preferably from about 4 wt % to about 30 wt %, or most preferably, for example, from about 4 wt % to about 20 wt %, based on the entire weight of the cavitated layer(s) of the films herein. (If more than one cavitated layer is present, the cavitated layers may collectively be considered as a cavitated layer or as the core layer of the film.) In some embodiments, it may be desirable that the incompatible cavitating agent contribute to the creation of at least about five percent of the cavities within the cavitated core layer, based upon the total number of cavities present within the cavitated layer.

As discussed above, the polymeric layer film may be cavitated by either an incompatible cavitation agent, by Beta-cavitation, or a combination of both. For embodiments where beta-cavitation is desired, it may be preferred that at least a majority of the cavities within the cavitated core layer, based upon the total number of cavities within the core layer, are cavitated by Beta-cavitation. It may also be desired that a majority by number of such Beta-cavitated, created cavities comprise a Beta-nucleating agent to initiate creation of the Beta-form crystals of polypropylene.

To provide additional strength or processability to the polymeric film, at least one additional polymeric layer may be co-extruded on one or both sides of the core layer. Such additional layers comprise substantially any extrudable, orientable, film-forming resin known in the art. Such materials include, but are not limited to, polypropylene, such as syndiotactic polypropylene, propylene-containing or ethylene-containing copolymers (including those copolymers containing three or more comonomers), low density polyethylene (LDPE), linear low density polyethylene (LLDPE), medium density polyethylene (MIDPE), high density polyethylene (HIDPE), ethylene-propylene copolymers, butylene-propylene copolymers, ethylene butylene copolymers, ethylene-propylene-butylene terpolymers, ethylene vinyl acetate copolymers, ethylene-vinyl alcohol copolymers, nylons, polymers grafted with functional groups, appropriate blends of these, and others known to those skilled in the art. In some embodiments, each additional layer, besides the core layer, in the polymeric film preferably may range in thickness from about 0.125 micron to about 4.0 microns. More preferably, each such additional layer of the polymeric film may be from about 0.5 micron to about 2.5 microns in thickness. These additional layers may be coextruded on either or both sides of the core. Films having such a multi-layer structure are represented, in simplified form, as having a structure “ABCDE” where “C” represents a base core layer, “B” represents an additional layer adjacent to the core, and “A” represents a further additional layer or skin layer applied to the outer surface of layer “B.” In such a film structure, the additional layer “B” may be referred to as a “tie-layer” or an “intermediate layer.” Layers “A” and “B” may be the same or different. Similarly, “D” and “E” represent additional layers on the other side of the core, “C” and they may be the same or different. Layers “B” and “D” may be the same or different, and layers “A” and “E” may be the same or different polymeric composition. In some embodiments, the outer or exterior skin layer “A” or “E” may also be embossed. Furthermore, metal-based layers, such as aluminum, silver, gold, or other metals, may be included in known fashion in the multilayer films of the polymeric layer. Thus, for example, a foil layer may be laminated to the polymeric film or a vapor-deposited metal-based layer can be deposited on the outer surface of the skin layer. As will be well known to person skilled in the art, multilayer films useful in connection with this invention may have from two to five or even more layers. For example, a three-layer “ACE” film comprises a core layer with skin layers adhered to each side of the core layer, with no tie layers. Alternatively, a three-layer ABC film comprises a core layer with a tie layer and a skin layer on the side of the tie layer opposite the core layer.

To modify or enhance certain properties of the mono-layer or multi-layer films used in the present invention, it is also possible for one or more of the film layers to contain appropriate additives in effective amounts. For example, the layers may further comprise additives such as, but not limited to anti-blocking agents, anti-static agents, coefficient of friction (COF) modifiers, processing aids, colorants, whiteners, clarifiers, UV stabilizers, and other additives known to those skilled in the art.

The oriented polymeric films may be prepared by commercially available systems for co-extrusion, including cast and blown film production systems. In a preferred process, the polymers are brought to the molten state and co-extruded from conventional extruders through a flat sheet die, the melt streams are combined in an adapter prior to being extruded from the die or within the die. After leaving the die, the multi-layer web is chilled and the quenched web is reheated and oriented.

After the base film has been extruded and cooled, the film is then oriented in at least the machine direction by being passed over a set of MD orientation rolls, blown or tentered. Both of these operations may stretch the film in the Machine Direction (MD). It may be preferred for many embodiments that the film is biaxially oriented by also stretching the film in the Transverse Direction (TD). Most preferably, the film is biaxially oriented to provide the desired opaqueness and loft created by cavitation. Preferably, the film may be oriented by stretching from about 3 to about 11 times in the machine direction (MD) at temperatures ranging from about 105° C. to about 150° C. and from about 3 to about 12 times in the transverse direction (TD) at temperatures ranging from about 150° C. to about 165° C. Biaxial film orientation can be carried out using either a simultaneous film stretching process or a sequential film-stretching process.

In some preferred embodiments, the polymeric layer(s), including the polymeric film component thereof, represent an outer or exterior component of the laminated composite structure. It is desirable for the polymeric layer to provide sufficient opacity to mask any appearance of the underlying base layer or adhesive material between the base and polymeric layer. This feature may be defined in terms of opacity or light transmission. It is desirable for many embodiments that the polymeric films used in the present invention have a light transmission of less than 60%, preferably less than 50%, more preferably less than 25%, and still more preferably less than 20%. Light transmission is the percentage of incident light that passes through a film and is largely determined by pigment and/or cavitation characteristics. Light transmission may be determined by shining a unidirectional, perpendicular light beam onto the film specimen and using a photo detector to measure the transmitted light, according to ASTM D 1003, using a spectrophotometer or hazemeter.

The desired opacity and durability may be accomplished by adjusting the types, amounts, and location of the cavitating agents. It is also possible to regulate film opacity by selectively utilizing pigments such as titanium dioxide in non-voided intermediate or skin layers of multilayer base films. An especially desirable type of high opacity multilayer film which can be acrylic-coated and used for lamination as an outer layer to base substrates are the films described in greater detail in U.S. Pat. No. 5,091,236, incorporated herein by reference. Some preferred cavitated films that may be suitable for use in various applications are multilayer films having a density prior to film coating, of from about 0.55 to about 0.85 g/cm³ after they have been oriented.

It is also desirable for the polymeric layer to provide sufficient cavitation for the polymeric layer to absorb any surface roughness or asperities of the surface of the base layer, such as a wood grain or particle shapes. Thereby, the films according to this invention may provide a smooth, aesthetically pleasing appearance. The exterior surface may be relatively smooth or relatively more matte in appearance. However, due to the thickness and compliance of the polymeric layer, the appearance of the finished exterior surface of the polymeric layer may be determined primarily by the polymeric layer and not by the surface features of the base layer.

A surprising advantage of the polymeric films is that the gauge or thickness of the polymeric layer is not critical. The desired exterior surface appearance and performance of the composite structure may be provided through use of a polymeric layer of substantially any thickness. However, preferred ranges of thickness may be determined as appropriate for a particular type of base substrate. Films of surprisingly thin thickness have been found to provide outstanding aesthetic and performance characteristics. The more important properties of the polymeric layer of this invention is that it comprise a cavitated, oriented, polymeric film, and is coated on at least one surface of the polymeric layer.

For example, for wood-based base substrates, desirable aesthetic and performance properties have been provided with a multilayer, cavitated, coated, oriented, polypropylene-based polymeric film, having an optical gauge thickness of from about 25 microns (about 1 mil) to about 90 microns (about 3.6 mils), including the thickness of the coating. For many preferred embodiments, the polymeric layer comprises a polymeric film having a thickness of from about 25 microns to about 60 microns and more preferably from about 30 microns to about 50 microns. The measurements are determined by optical or laser measurement, as cavitated films tend to compress under mechanical measurement. Information on optical gauge test procedures is available from instrument manufacturers, such as “Beta Laser Mike,” Dayton, Ohio, or at www.betalasermike.com. The thickness, cavitation, and loft created through orientation may be varied to produce a film of appropriate thickness and yield, as needed to mask the surface irregularities of the particular base substrate being used.

The thickness relationship of the coated film layers can vary. For example, the core layer may constitute about 40 to about 100 percent of the total uncoated film thickness. Any intermediate layers may have a thickness ranging from about 0 to about 30 percent of the total uncoated film thickness while any outer skin layers may range from about 0 to about 10 percent of the total film thickness.

### Polymeric Layer Coating

In accordance with the present invention, the polymeric layer, preferably the polymeric film of the polymeric layer, as described herein are coated with a coating material, preferably before they are laminated to the base substrate. The coating may be applied to either or both sides of the polymeric layer and may thereby perform in at least one of two primary functions. When the coating is applied to a side of the polymeric layer that will be applied to or placed in contact with the adhesive, the coating may function as a primer or energized surface to improve adhesion and/or wet-out of the adhesive on the polymeric layer. When the coating is applied to the opposing side of the polymeric layer, the coating may function as a primer or energized surface to improve printability or wet-out of inks or other coating materials on the exterior surface of the polymeric layer.

Prior to application of the coating, in some embodiments, depending upon the surface energy of the polymer film, the film may be surface-treated and/or may be primed with a primer layer to, in addition to other known benefits of primers, improve adhesion of the coating. If a primer is used to treat the surface of the film prior to application of the coating, exemplary suitable primer materials may include poly(ethyleneimine) primers, epoxy primers, and the like.

Surface-treatment of the exposed outer surfaces of the film may also be included to increase their surface energy and thereby improve coating or ink wet-out to insure that the coating layer will strongly adhere thereto, reducing the possibility of the ink or coating peeling or being stripped from the film. Surface treatment can be accomplished by any suitable technique, such as film chlorination, (i.e., exposure of the film surface to aqueous chlorine), treatment with oxidizing agents such as chromic acid, hot air or steam treatment, flame treatment, plasma treatment, corona treatment, and the like, with flame and plasma treatment being particularly preferred. Although any of these techniques may be effectively employed to pretreat the film surface, a particularly desirable method of treatment for some embodiments is corona treatment, which comprises exposing the film surface to a high voltage corona discharge while passing the film between a pair of spaced electrodes. The exterior surface of the polymeric layer may be further processed, such as by coating and/or metallization, including vapor-metallization, embossing and/or printing, to provide a desired appearance to the exterior surface of the polymeric layer.

The cavitated, oriented polymeric film preferably includes a coating on at least one side thereof and may more preferably be coated on both sides of the polymeric layer. After treatment and/or priming of the film surfaces, the coating composition may be applied thereto. A coating may comprise any material which will, as one function, provide desirable adhesion of the polymeric layer to the base substrate of the base layer when a thermosetting adhesive is used between these two layers of the laminated structure, or provide desirable printability or finishing to the exterior surface of the composite structure. In some preferred compositions, the coating material may be acrylic-based. Acrylic-based coating compositions may comprise an acrylic copolymer emulsion or solution. Such acrylic copolymer may include at least 5 wt % of a polar, functional comonomer based upon the total weight of the copolymer. Preferably, the polar functional comonomer can be present in an amount of from about 5 wt % to about 60 wt % and, most preferably, from about 10 wt % to about 50 wt %.

The polar, functional comonomer used in forming the acrylic copolymer can include, for example, acrylic acid; methacrylic acid; alkyl, e.g., methyl or ethyl, esters of acrylic and methacrylic acid; hydroxyethyl acrylate; hydroxyethyl methacrylate; hydroxypropyl acrylate; hydroxypropyl methacrylate; crotonic acid; fumaric acid; itaconic acid; and/or maleic acid. The weight average molecular weight of the acrylic copolymer may generally be at least about 10,000. Preferably, the weight average molecular weight of the acrylic copolymer may range from about 20,000 to about 1,000,000 and, more preferably, from about 50,000 to about 500,000. Film coating compositions based on acrylic copolymers of this type are described in greater detail in U.S. Pat. No. 4,981,758, incorporated herein by reference.

Specific types of acrylic-based coating compositions preferred for use with various preferred polymer film compositions include acrylic coatings such as described in U.S. Pat. Nos. 3,753,769 and 4,695,503, both of which are also incorporated herein by reference. These coating compositions may comprise polymers of (a) up to 15, preferably from about 2 to 15, parts by weight of an α, β-monoethylenically unsaturated carboxylic acid and (b) at least 85, preferably from about 85 to 98, parts by weight of neutral monomer esters such as combinations of alkyl acrylate esters and alkyl methacrylate esters. A typical preferred acrylic copolymer may be, for example, a terpolymer comprising at least one and preferably all three of methylmethacrylate, methylacrylate, and methacrylic acid.

The coating compositions may also contain other coating additive components, such as slip agents and anti-blocking agents. Exemplary slip and/or blocking agents include finely divided silica, polymethyl methacrylate, N-acyl sarcosines, waxes and wax-like materials, etc. Such additional components of an acrylic coating compositions that are useful for preparing the films as described herein are discussed in greater detail in U.S. Pat. Nos. 3,753,769; 4,695,503; and 4,981,758, each of which are incorporated herein by reference.

The coating can be applied to at least one surface or to both surfaces of the polymeric layer via any known coating method. The composition on one side of the polymeric layer may be the same as the composition on the other side, or one side may include a coating composition that differs compositionally or in weight, from the opposing side coating. The application method will be determined by such factors as equipment availability, coating type, desired coating performance properties, and coating weight. Such coating methods may include, for example, co-extrusion, roll-coating, gravure-coating, Meyer rod, flood coating, and spraying. The coating composition can be applied in such amount that there will be deposited, upon drying, a smooth, evenly distributed coating layer, generally on the order of from about 0.25 micron to about 5 microns thickness (equivalent to about 0.2 to 3.5 gram per 1000 square inches of film). Generally, the dried coating composition may comprise from about 1 wt % to about 25 wt %, more preferably from about 7 wt % to about 15 wt %, of the entire coated film composition. The coating on the film may be dried by hot air, radiant heat or by any other convenient means. In some preferred compositions, the coating material will be applied to both sides of the polymeric film.

### Lamination Adhesive

The coated polymeric layer(s) as described herein is laminated to the base layer, using an adhesive. The adhesive is positioned between the polymeric layer and the base layer. Preferred adhesives are thermosetting adhesives that are at least partially cured to properly bond the polymeric layer(s) to the base substrate. A thermosetting type of adhesive may be defined broadly as including, in one aspect, an adhesive that becomes set or cured into a given polymer-molecule network, normally through the catalytic action of heat, chemical reaction, radiation, including UV radiation, pressure, and/or a combination of these factors. In another aspect, a thermosetting adhesive may be further defined to include hot-melt adhesives that require the addition of heat, radiation, and/or pressure to cause the adhesive material to melt to become applicable and thereafter, through cooling or the removal of the heat or pressure, the adhesive cures by cooling and setting up to bond the surface(s) of interest. A thermosetting adhesive may cross-link during the process of heating, curing, setting up, activation, and/or cooling. As the name suggests, cross-linking is the process of forming a network of intertwining linkages of polymer chains with each other and/or with other types of molecules in the adhesive. As a result of this process, preferred thermosetting adhesives may become infusible and insoluble. It may also be preferred that the adhesive coverage be over substantially the entire surface to be bonded, while in other embodiments the adhesive may be applied in patterns or along perimeters, edges, or other coverages that are less than the entire surface area.

Various types of thermosetting adhesives are known in the art and can be used to prepare the laminated composite structures of this invention. Some preferred types of thermosetting adhesives include aminoplast resin adhesives, epoxy resin adhesives, phenol-formaldehyde adhesives, and polymeric di-isocyanates. Thermosetting adhesive can be supplied and used in either liquid or solid form. Some preferred thermosetting adhesives suitable for use herein may be cured by subjecting them to a temperature of at least about 140° C., more preferably temperatures of from about 190° C. to about 220° C. for suitable duration of time as required under the particular facts related to the adhesive, conditions, and materials used, to fully cure the adhesive. It is typically preferred that the adhesive be substantially fully cured during the manufacturing process but there may be suitably acceptable instances where the adhesive is only partially cured during manufacturing but may continue to self-cure over the subsequent hours or days.

One preferred type of thermosetting adhesive that may be suitable for use in bonding the polymeric layer(s) to the base layer of this invention comprises aminoplast resins. Aminoplast resins are condensation products of an amino compound with a free formaldehyde-like compound. Exemplary, suitable amino compounds for forming aminoplast resin adhesives include urea, thiourea, melamine, melam, melem, ureidomelamine, and the like with urea, melamine and combinations thereof being most preferred. Suitable formaldehyde-like compounds include formaldehyde itself and paraformaldehyde.

Aminoplast resin adhesives are frequently employed along with acid catalyst materials, cross-linking agents, and/or hardeners to promote curing of the adhesives. Suitable acidic catalysts for use with aminoplast adhesives can include acidic metal, salts such as ammonium, aluminum, magnesium and zinc phosphates, sulfates, persulfates, chlorides and nitrates. Suitable cross-linkers or hardeners may include diol ethers or phenolic resins such as resorcinol resins. Exemplary aminoplast resin adhesives, including catalysts, hardeners, and cross-linkers therefore are described further in, U.S. Pat. Nos. 3,993,755; 6,734,275; and 6,881,817, all of which are incorporated herein by reference.

### Laminate Preparation

The laminated composite structures of the present invention may be prepared by any suitable laminating process that renders the desired final structure. The process may be performed using any apparatus and equipment that suitably assembles the requisite components of the composite structure into the above-described composition. The details on arrangement of the production equipment components are not critical, so long as the arrangement facilitates production of the laminated composite structure. What is important is the ability of the equipment to merge a polymer web such as a multilayer, oriented, cavitated film, with a laminating adhesive and a base layer, such as a wood-based substrate. The base layer, adhesive, and polymeric layer are combined into a laminated composite structure and then cured or set up as needed to form a permanent bond.

A suitable process and apparatus should be capable of combining at least the base layer(s), the polymeric layer(s), and the adhesive together, into an integral laminated composite structure, within a portion of the apparatus that may be defined broadly as the lamination zone. The process and apparatus should position each of the base layer, the adhesive, and the polymeric layer to common contact to form a laminated substrate. To complete the process by setting, curing, or activating the adhesive, the lamination zone should also include equipment necessary to apply at least one of heat, radiation, a catalyst or chemical component within the adhesive, pressure, and/or a combination thereof, to the combined components to fixedly bond the polymeric layer to the base layer, using the adhesive as the primary bonding agent. In many preferred embodiments, the end product is a wood-polymer laminated composite structure that possesses a relatively smooth, finished appearance on the exterior surface of the polymeric layer. The process may also be performed to the opposing side of the base layer, simultaneously or sequentially with respect to the first side of the base layer, to produce a laminated composite substrate having a polymeric layer on each exterior side of the base layer.

Examples of process and apparatus setups which can be modified for preparing the laminated composite structures discussed herein are described, for instance, in U.S. Pat. Nos. 3,994,769 and 4,865,912; European Patent No. EP-B-840,674; and PCT Application No. WO 2004/054769. All of these patent publications are incorporated herein by reference.

In one aspect of the present invention, a preferred process is described in the Summary, for preparing the laminated composite structures herein. This preferred process employs a particular arrangement of laminate layer conveying methods and equipment and heat and pressure-providing methods and equipment to convey the base layers, polymeric layers, and adhesive to a lamination zone and to provide the requisite heat and pressure or other energy necessary to cure the adhesive and form the desired laminated composite structures. The preferred conveying means and the preferred heat and pressure-providing means will generally comprise rollers and roller pairs, e.g., drums, (The term “drum” is typically used in the art to denote a cylindrical member which is often larger in diameter than smaller types of cylindrical members called “rollers.” However, for purposes of this invention, the terms “drum” and “roller” may be used interchangeably.)

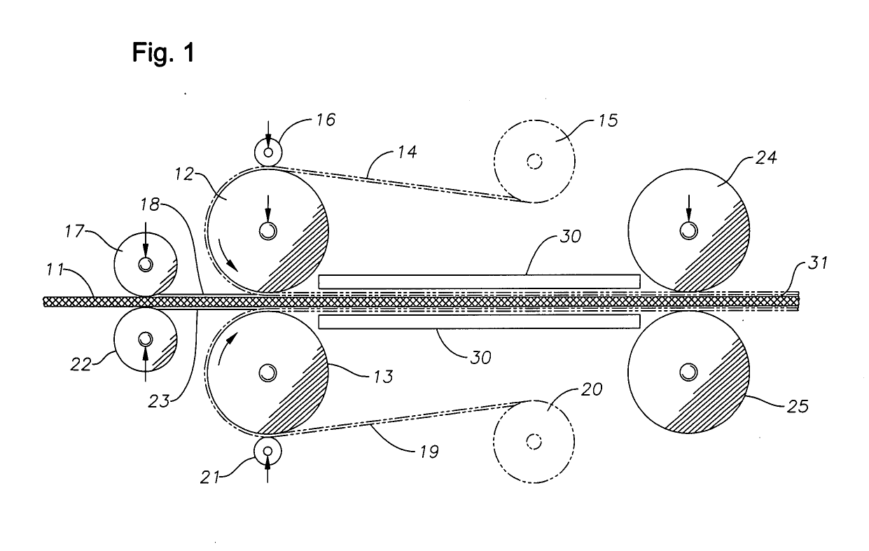

One exemplary process embodiment using sets of rollers and drums is illustrated by FIG. 1. FIG. 1 illustrates a pair of feeding rollers 12 and 13, and a pair of heating/pressure rollers 24 and 25, with these pairs of rollers comprising a lamination zone. Each of the drums 12, 13, 24, and 25 may be heated. A base layer of wood-based chipboard 11, destined to be laminated, is conveyed through the feeding drums 12 and 13 and into the lamination zone.

A roll of decorative, acrylic-coated, cavitated, oriented multi-layer, polypropylene (OPP) film 14 is unwound from a reel 15 and fed into the nip between film-feed drum 12 and a pressure roll 16. The film supplied from reel 15 may comprise, for example, a base film having an isotactic polypropylene core containing polybutylene terephthalate particles as a cavitating agent. This film may comprise a co-extruded core and a non-voided layer of isotactic polypropylene adjacent to the cavitated core on either side or both sides of the core. This base film may be corona-treated on both sides and then an acrylic coating may be applied to both sides. The acrylic coating which is applied to the base film and dried may comprise, for example, on a solids basis, 70 wt % of a methylmethacrylate/methylacrylate/methacrylic acid terpolymer, 3.8 wt % of a camuba wax slip/anti-block agent, 26 wt % of colloidal silica antiblock, and 0.2 wt % of talc anti-block.

The base layer 11 is passed through the nip between a pair of coating rollers 17 and 22 before being fed to the lamination zone through the nip between feed drums 12 and 13. The upper coating roller 17 may coat the upper surface of the base layer 11 with a layer of liquid adhesive 18 supplied from a reservoir (not shown). In this manner the upper surface of the chipboard 11 may be coated with the layer of adhesive 18 before the chipboard contacts the film strip 14 at the nip between feed drums 12 and 13. Alternatively, the adhesive could be coated or sprayed onto film 14 as a liquid or sprinkled or otherwise applied onto the chipboard 11 or on the acrylic-coated film 14 as a solid instead of or in addition to being applied as a liquid to the chipboard surface. The acrylic-coated film 14 passes around drum 12 and is contacted with the adhesive 18 coated upper surface of base layer 11 at the nip between the heated film-feeding drums 12 and 13.

To laminate the underside of the chipboard 11 with a polymeric layer, another roll of the same or a different acrylic-coated, cavitated, OPP film 19, such as described above may be likewise unwound from a reel 20. This strip 19 may be pressed onto the film-feed drum 13 by a pressure roll 21. The underneath side of the base layer 11 may also be coated with an appropriate thermosetting adhesive 23, such as by coating roll 22, which may obtain the liquid adhesive from a reservoir (not shown). In this manner, a layer of liquid adhesive 23 may be applied to the underneath side of the base layer 11 before the base layer passes into the lamination zone.

The second-side film 19 may pass around the film-feeding drum 13 and contact the underside of the base layer 11 at the nip between the heated film-feeding drums 12 and 13. The drums 13 and 25 may be pressed against the drums 12 and 24 respectively by adjustable devices (not shown) with pressure and nip setting variability, as necessary according to the material being laminated and end-product specs.

The base layer 11, laminated on one side with adhesive layer 18 and decorative coated film strip 14, and on the other side with adhesive layer 23 and decorative coated film strip 19, may then be optionally passed through a further heating channel 30, for example a microwave channel, to reach and maintain a suitable laminating or setting temperature. Alternatively, there need be no heating channel 30 and the requisite heat and pressure can be supplied solely by the drums 24 and 25 or by other heat source. Some equipment may possess multiple sets of heat and/or pressure drums, such as drums 24 and 25, to provide additional heat and/or to speed up the processing. The heating channel 30 may be positioned before or after the drums 24 and 25 or between sets of drums such as 24 and 25. In still other embodiments, the heating channel 30 may be positioned before the rollers 24 and 25, to partially cure the adhesive prior to lamination. The laminating and further processing also may be continued after the nip between the drums 24 and 25 to further process laminated product 31, such as by embossing, metallization, further coating, further treating, further laminated, cutting, and stacking, such as by other apparatus not shown.

According to one exemplary process utilizing an oriented polypropylene (“PP”) based polymeric layer, the temperature provided by the feeding drums 12 and 13 (and in some embodiments rollers 18 and 22) should be set at a relatively low temperature before lamination, e.g., from about 100° C. to about 140° C. to avoid melting or sticking the OPP film. For embodiments using thermosetting adhesives, after lamination, such as at heated rollers 24 and 25, the subsequent heating of the formed laminated composite structure 31 should be sufficient to substantially cure the thermosetting adhesive. Temperature ranges provided for heated rollers 24, 25 and any subsequent rollers or drums may typically operate within a range from about 190° C. to about 220° C. to provide the energy needed for curing. Because the multilayer film is at least partially adhered to the board or base layer, a heat sink is created by the base layer that permits the film to tolerate the increased temperature without adversely distorting or melting the film. The thermosetting adhesive may also further cure to a state of full curing after processing at rollers 24 and 25, due to base layer heat retention and dissipation.

The laminated composite structure may be further processed by embossing, coating, further laminating, and/or metallizing, such as by vapor-metallization, on an exterior surface of the polymeric layer, to provide the desired aesthetic appearance and/or functional properties for such exterior surface. The exterior surface may also be printed, such as with a wood-grain pattern or with other printed features. Embodiments having the polymeric layer on each side of the base layer may have such further processing performed to both sides, as appropriate.

The resulting laminated composite structures can be further processed such as by cross-cutting with a circular saw, routing, and/or hole-drilling. Such composite structures can then be further used by assembling them with other components. This may generally include affixing the composite structure described herein into a set relationship with at least one other component. One example is in the fabrication of furniture components. This can be accomplished using any conventional affixing means such as gluing, nailing, screwing or bolting and the like.

The laminated composite structures of this invention have several advantages in comparison with laminates having a decorative layer fashioned from resin-impregnated paper. For example, two-side acrylic-coated polymeric films as a decorative outer layer can provide a surface which can be easily embossed and/or printed with water-based inks. Further, the reverse side acrylic coating may provide excellent bonding to the base substrate when thermosetting adhesives are used. The acrylic coating may permit fabrication of the laminate composite structure without the use of relatively expensive hot melt adhesives which are typically used with polymeric films.

The use of cavitated films, such as those having a density within the preferred range of 0.55 to 0.85 grams/cm³, as the decorative outer layer allows good opacity to be maintained in the film after lamination. This also provides films that hide surface irregularities in the base substrate and may permit embossing and emphasizing the decorative printed pattern, such as a wood grain pattern. The density of the film also gives the film on the laminated products sufficient internal cohesion to resist internal, Z-dimension tearing or splitting within the film. Finally, considering that some small degree of de-cavitation or de-lofting may occur within the cavitated portion of the film during lamination, due to the heating process, the edge of the film may be substantially hidden when the laminate is viewed from the side. This allows white opaque films to be used as the decorative outer layer even for dark print, whereas laminated paper decorative layers have to be supplied in different colors, depending upon the color of the print to be used.

Another exemplary process for preparing a laminated composite structure according to this invention may comprises the steps of; A) providing a lamination zone comprising at least (i) a polymeric layer conveyor, (ii) a base layer conveyor, and (iii) at least one of a heating element, a radiating element, a compressing element, and an adhesive-applying element; B) conveying base layer comprising a base substrate to the lamination zone; C) conveying at least one polymeric layer to the lamination zone, the at least one polymeric layer comprising a coated, cavitated, and oriented polymeric film; D) applying an adhesive to at least one of the base layer and the at least one polymeric layer; E) contacting within the lamination zone, the base layer to the adhesive and the at least one polymeric layer to the adhesive, to form a laminated substrate having the adhesive positioned between the base layer and the at least one polymeric layer; and applying at least one of heat, radiation, and direct pressure to the laminated substrate to form a laminated composite structure.

The lamination zone serves as an area or a stage in the lamination process, wherein the layers are combined to form the laminate. The lamination zone may be defined broadly to include a physical zone or functionally as a series of steps or stages within the process. The lamination zone may preferably include at least (i) a polymeric layer conveyor to feed the multilayer film or other polymeric layer into the lamination zone, (ii) a base layer conveyor to feed the base layer into the lamination zone, (iii) an adhesive source, and (iv) at least one of a curing source and a compressing element to process or cure the adhesive. The base layer may preferably comprise a wood-based substrate. And the at least one polymeric layer may preferably comprise a first multilayer polymeric film for one side of the substrate and optionally a second multilayer polymeric film for the opposing side of the substrate.

The step of conveying may be defined broadly to include substantially any method and equipment as necessary to feed the base layer or the polymeric layer into the lamination zone. This may be done using rollers, conveyor belts, and/or drums as desired, to move the component into and through the lamination zone. The step of applying the adhesive is also defined broadly to include substantially any method of applying an adhesive, as determined by the properties of the particular adhesive being used and the desired thickness of the adhesive layer. Applying the adhesive may be done either in the lamination zone or before the base layer and/or polymeric layer enter the lamination zone.

The step of curing the adhesive is also defined broadly to include whatever process is necessary to activate, cross-link, cure, set-up, dry, heat, and/or cool the adhesive after the base layer, the adhesive, and the polymeric layer are combined in the lamination zone. Curing may, for example, include the steps of applying at least one of heat, radiation, and direct pressure for sufficient length of time necessary to cure the laminated substrate, and may be performed using separated, dedicated components, such as a curing oven or device, and/or heated components throughout the process, such as heated rollers or drums.

The process may also comprise the step of applying direct pressure to each of the base layer, such as by nip roller or by a pair of rollers or conveyors, to compress the layers together to establish a good bond with the adhesive, provide uniform desired thickness, and produce a substantially flat or uniform appearing outer surface to laminated composite structure. Each of the steps in the process may be performed substantially continuously to facilitate the continuous production of laminated composite substrates. For example, a pair of rollers may be positioned to form a nip, through which the base layer, polymeric layer, and adhesive may be fed to apply pressure and substantially continuously produce the laminated composite substrate.

As in the described composition, the base layer utilized in the process may comprise a substrate selected from the group consisting of particleboard, fiberboard, orientated strandboard, hardboard, waferboard, plywood, chipboard, strawboard, cardboard, melamine board, masonite, homasote, MDF board, polymeric-type members, wood veneer, and solid lumber. In still other embodiments, the process may further comprise the step of surface-treating at least one side of the polymeric layer, before lamination to the base layer and/or after lamination to the base layer. Treatment may be by one or more of corona discharge treatment, plasma treatment, flame treatment, chemical treatment, and primer coating. The process of applying the adhesive may be by substantially any suitable technique, depending primarily upon the type and weight of adhesive used, by at least one of spraying, rolling, flooding, gravure, reverse gravure, meyer rod, and extrusion of the adhesive.

In yet another process, the laminated composite structure may be further processed by at least one of printing, embossing, vapor-metallizing, and further coating the at least one polymeric layer. Such step may be performed on the polymeric layer either before lamination to the base layer, or after forming the laminated composite structure.

After formation of the laminated structure is complete, the formed laminated composite structure may be still further processed, including utilizing or integrating the produced composite structure in a production product, for example in a component for use in fabrication of another product or member. The further process may include the step of passing the laminated composite structure out of the lamination zone and thereafter of subjecting the laminated composite structure to a further processing operation such as gluing, nailing screwing, clamping, bolting, cutting, sawing, routing, milling, drilling, and stacking the laminated composite structure. Such laminated composite structure may be suitable for use as in the fabrication of a manufactured article, such as a piece of furniture, flooring, a wall (such as in a manufactured home or trailer), a cabinet, a furniture item, a graphic support member, an environmental barrier member, and a structural support member. In still other uses or applications, the laminated composite structure may be decorated or otherwise made aesthetically or functionally improved, such as by printing, painting, metallizing, and embossing the at least one polymeric layer.

While the invention has been described in detail and with reference to specific embodiments and examples, it will be apparent to one of ordinary skill in the art that various changes and modifications can be made therein without departing from the spirit of the invention. The examples recited herein are demonstrative only and are not meant to be limiting. Further embodiments are included within the following claims.

What is claimed is:

1. A laminated composite structure comprising:
A) a base layer comprising a base substrate;
B) at least one polymeric layer comprising a cavitated and oriented polymeric film, the polymeric layer having a coating on at least one surface thereof; and
C) an adhesive interposed between the base layer and the at least one polymeric layer to bond the at least one polymeric layer with the base layer.

2. The laminated composite structure according to claim 1, wherein the coating of the polymeric film comprises an acrylic-based coating.

3. The laminated composite structure according to claim 1, wherein said base substrate is selected from the group consisting of particleboard, fiberboard, orientated strandboard, hardboard, waferboard, plywood, chipboard, strawboard, cardboard, melamine board, masonite, homasote, MDF board, wood veneer, a polymer-based member, and solid lumber.

4. The laminated composite structure according to claim 1, wherein the base layer comprises a first surface and an opposing second surface and the at least one polymeric layer comprises a first polymeric layer and a second polymeric layer; and wherein the first surface of the base layer is bonded to the first polymeric layer and the second surface of the base layer is bonded to the second polymeric layer.

5. The laminated composite structure according to claim 1, wherein the base layer comprises a first surface and an opposing second surface and at least one of the first surface and second surface of the base layer is a substantially planar surface.

6. The laminated composite structure according to claim 1, wherein the adhesive is a thermosetting adhesive.

7. The laminated composite structure according to claim 6, wherein the adhesive is thermoset by at least one of heat curing, radiation curing, and direct pressure.

8. The laminated composite structure according to claim 6, wherein the adhesive comprises a two-part resin.

9. The laminated composite structure according to claim 1, wherein the at least one polymeric layer comprises polypropylene.

10. The laminated composite structure according to claim 1, wherein the at least one polymeric layer comprises a multilayer polymer film including at least one cavitated core layer and at least one non-cavitated layer.

11. The laminated composite structure according to claim 10, wherein at least about five percent of the cavities within the cavitated core layer are cavitated with an incompatible particulate cavitating agent.

12. The laminated composite structure according to claim 10, wherein at least majority of the cavities created within the cavitated core layer are created by Beta-cavitation.

13. The laminated composite structure according to claim 12, wherein at least a majority of the cavities created by Beta-cavitation comprise a Beta-nucleating agent.

14. The laminated composite structure according to claim 1, wherein the at least one polymeric layer comprises a core layer including from about 2 wt % to about 40 wt % of a cavitating agent based upon the total weight of the core layer.

15. The laminated composite structure according to claim 1, wherein the at least one polymeric layer comprises a core layer including from about 4 wt % to about 20 wt % of a cavitating agent based upon the total weight of the core layer.

16. The laminated composite structure according to claim 1, wherein the at least one polymeric layer includes a cavitating agent comprising particles of at least one of polybutylene terephthalate, acrylic resin, nylon, polycarbonate, glass, ceramic, metal, and calcium carbonate.

17. The laminated composite structure according to claim 11, wherein at least a majority by weight of the incompatible cavitating agent particles comprise an overall mean particle diameter of from about 0.1 to about 5 microns.

18. The laminated composite structure according to claim 1, wherein the at least one polymeric layer comprises a cavitated core layer, a first non-voided polymeric layer on a first side of the core layer, and a second non-voided polymeric layer on a second side of the core layer.

19. The laminated composite structure according to claim 1, wherein the at least one polymeric layer is biaxially oriented.

20. The laminated composite structure according to claim 18, wherein the at least one polymeric layer is coated on both an exterior surface of the first non-voided polymeric layer and an exterior surface of the second non-voided layer, with an acrylic-based coating.

21. The laminated composite structure according to claim 1, wherein the at least one polymeric layer has a density of from about 0.55 to about 0.85 g/cm³, not considering the coating thereon.

22. The laminated composite structure according to claim 1, wherein the at least one polymeric layer is surface-treated on at least one side thereof.

23. The laminated composite structure according to claim 1, wherein the at least one polymeric layer is surface-treated on both sides thereof.

24. The laminated composite structure according to claim 1, wherein the at least one polymeric layer is surface-treated by at least one of corona discharge treatment, plasma treatment, flame treatment, and primer coating.

25. The laminated composite structure according to claim 1, wherein the coating on the at least one polymeric layer comprises an acrylic-based coating, wherein the acrylic-based coating comprises monomers selected from the group consisting of acrylic acid, methacrylic acid, methyl or ethyl esters of acrylic and methacrylic acid, hydroxyethyl acrylate, hydroxyethyl methacrylate, hydroxypropyl acrylate, hydroxypropyl methacrylate, crotonic acid, fumaric acid, itaconic acid, and maleic acid.

26. The laminated composite structure according to claim 25, wherein the acrylic-based coating comprises a terpolymer comprising at least one of methylmethacrylate, methylacrylate, and methacrylic acid.

27. The laminated composite structure according to claim 1, wherein the coating further comprises at least one of a slip agent and an anti-blocking agent.

28. The laminated composite structure according to claim 27, wherein the at least one of a slip agent and an anti-blocking agent is selected from the group consisting of finely divided silica, N-acyl sarcosines, polymethyl methacrylate, waxes, and wax-like materials.

29. The laminated composite structure according to claim 1, wherein the coating on the at least one polymeric layer ranges in thickness from about 0.25 micron to about 5 microns.

30. The laminated composite structure according to claim 6, wherein the thermosetting adhesive comprises an aminoplast resin.

31. The laminated composite structure according to claim 9, wherein the thermosetting adhesive comprises an aminoplast resin.

32. The laminated composite structure according to claim 31, wherein the aminoplast resin is selected from the group consisting of urea-formaldehyde and melamine-formaldehyde aminoplasts.

33. The laminated composite structure according to claim 1, wherein the adhesive comprises an epoxy-resin.

34. The laminated composite structure according to claim 1, wherein the base layer further comprises a second base substrate.

35. The laminated composite structure according to claim 1, wherein the base layer comprises at least one of a metal substrate, a rigid polymer substrate, and a rigid foam substrate.

36. The laminated composite structure according to claim 1, wherein the at least one polymeric layer comprises at least one multilayer polymeric film.

37. The laminated composite structure according to claim 36, wherein the multi-layer film comprises a metal-based layer.

38. The laminated composite structure according to claim 37, wherein the metal-based layer is deposited by vapor metallization.

39. The laminated composite structure according to claim 36, wherein the multi-layer film comprises an embossed layer.

40. A laminated composite structure comprising:
A) a base layer comprising a base substrate, the base layer having a first surface on a first side of the base layer and a second surface on a second side of the base layer;
B) a first polymeric layer on the first surface of the base layer and a second polymeric layer on the second surface of the base layer; and
C) a thermosetting adhesive interposed between the first surface and the first polymeric layer, and a thermosetting adhesive interposed between the second surface and the second polymeric layer;
wherein each of the first polymeric layer and the second polymeric layer comprise a coated, cavitated, oriented polymeric film including a polypropylene core layer having a density of from about 0.55 to about 0.85 g/cm³.

41. The laminated composite structure according to claim 40, wherein the laminated composite structure is formed or cut into substantially planar members that are stackable.

42. A process for preparing a laminated composite structure, which process comprises the steps of:
A) providing a lamination zone comprising at least (i) a polymeric layer conveyor, (ii) a base layer conveyor, and (iii) at least one of a heating element, a radiating element, a compressing element, and an adhesive-applying element;
B) conveying a base layer comprising a base substrate to the lamination zone;
C) conveying at least one polymeric layer to the lamination zone, the at least one polymeric layer comprising a coated, cavitated, and oriented polymeric film;
D) applying an adhesive to at least one of the base layer and the at least one polymeric layer;
E) contacting within the lamination zone, the base layer to the adhesive and the at least one polymeric layer to the adhesive, to form a laminated substrate having the adhesive positioned between the base layer and the at least one polymeric layer; and
F) applying at least one of heat, radiation, and direct pressure to the laminated substrate to form a laminated composite structure.

43. The process according to claim 42, further comprising the step of:
at least partially curing the adhesive by maintaining the at least one of heat, radiation, and direct pressure for sufficient time to fixedly bond the base layer to the at least one polymeric layer.

44. The process according to claim 42, further comprising the step of:
applying direct pressure to each of the base layer and the at least one polymeric layer to fixedly bond the base layer to the at least one polymeric layer.

45. The process according to claim 42, wherein the step E) of contacting within the lamination zone further comprises the step of contacting the base layer to the adhesive and the at least one polymeric layer to the adhesive is performed in a substantially continuous process by at least one of a roller, a conveyor, and a drum.

46. The process according to claim 42, wherein the step of applying at least one of heat, radiation, and direct pressure, further comprises the step of applying at least one of heat and direct pressure by at least one of a heated roller, a heated conveyor, or a heated drum.

47. The process according to claim 42, further comprising the step of providing a nip to cause the base layer and the at least one polymeric layer to further engage the adhesive, the nip including at least two rollers, drums, conveyors, or combinations thereof to form the nip between the at least two rollers.

48. The process according to claim 47, further comprising the step of conveying the base layer, the at least one polymeric layer, and the adhesive through the nip to compress the base layer with the polymeric layer.

49. The process according to claim 42 wherein the base substrate is selected from the group consisting of particleboard, fiberboard, orientated strandboard, hardboard, waferboard, plywood, chipboard, strawboard, cardboard, melamine board, masonite, homasote, wood veneer, and solid lumber.

50. The process according to claim 42 wherein the at least one polymeric layer comprises a multilayer polymer film including at least one cavitated core layer and at least one non-cavitated layer.

51. The process according to claim 50, wherein at least about five percent of the cavities within the cavitated core layer are cavitated with an incompatible particulate cavitating agent.

52. The process according to claim 50, wherein at least a majority of the cavities within the cavitated core layer are created by Beta-cavitation.

53. The process according to claim 42 wherein the at least one polymeric layer includes a cavitating agent comprising particles of at least one of polybutylene terephthalate, acrylic resin, nylon, polycarbonate, glass, ceramic, metal, and calcium carbonate.

54. The process according to claim 42 further comprising the step of surface-treating at least one side of the polymeric layer.

55. The process according to claim 54, wherein the at least one polymeric layer is surface-treated by at least one of corona discharge treatment, plasma treatment, flame treatment, and primer coating.

56. The process according to claim 42, wherein the thermosetting adhesive comprises an aminoplast resin.

57. The process according to claim 56, wherein the aminoplast resin is selected from the group consisting of urea-formaldehyde and melamine-formaldehyde aminoplasts.

58. The process according to claim 42, wherein the adhesive comprises an epoxy-resin.

59. The process according to claim 42, wherein the step of applying the adhesive comprises applying the adhesive by at least one of spraying, rolling, flooding, gravure, reverse gravure, and meyer rod.

60. The process according to claim 42, wherein the step of applying the adhesive comprises applying the adhesive by extrusion.

61. The process according to claim 42, wherein the base layer comprises a second base substrate.

62. The process according to claim 42, wherein the at least one polymeric layer comprises at least one multilayer polymeric film.

63. The process according to claim 62, further comprising the step of metallizing an exterior surface of the polymeric layer after the laminated composite structure is formed.

64. The process according to claim 42, further comprising the step of at least one of printing, embossing, vapor-metallizing, and further coating the at least one polymeric layer.

65. The process according to claim 64, wherein the step of at least one of printing, embossing, vapor-metallizing, and further coating the at least one polymeric layer is performed after forming the laminated composite structure.

66. The process according to claim 42, further comprising the step of passing the laminated composite structure of step F) out of the lamination zone and thereafter of subjecting the laminated composite structure to a further processing operation selected from the group consisting of cutting, sawing, routing, milling, drilling, and stacking the laminated composite structure.

67. The process according to claim 66 further comprising the step of joining at least a portion of the laminated composite structure with other components to form a manufactured article.

68. The process according to claim 67, wherein the step of joining comprises affixing the portion of the laminated composite structure in set relationship to at least one other component by at least one of gluing, nailing screwing, clamping, or bolting.

69. The process of using the laminated composite structure according to claim 42, comprising the step of incorporating the laminated composite structure in at least one of a floor, a wall, a cabinet, a furniture item, a graphic support member, an environmental barrier member, and a structural support member.

70. The process of using the laminated composite structure according to claim 42, further comprising the step of decorating the laminated composite structure member with at least one of printing, painting, and embossing the at least one polymeric layer.
